(19) United States
(12) Patent Application Publication
(10) Pub. No.: US 2010/0113041 A1
(43) Pub. Date: May 6, 2010

(54) METHOD OF SIGNALLING SYSTEM INFORMATION, METHOD OF RECEIVING SYSTEM INFORMATION, RADIO BASE STATION AND RADIO COMMUNICATION TERMINAL

(76) Inventors: Maik BIENAS, Braunschweig (DE); Hyung-Nam CHOI, Hamburg (DE); Martin HANS, Bad Salzdetfurth (DE); Manfred ZIMMERMANN, Sauerlach (DE)

Correspondence Address: INFINEON TECHNOLOGIES AG;Patent Department, MUC 11.1.507, P.O. Box 221644, Munich, 80506, DE

(21) Appl. No.: 12/262,197

(22) Filed: Oct. 31, 2008

(51) Int. Cl. H04W 72/00

(52) U.S. Cl. 455/450

(57) ABSTRACT

A method of signalling system information and a method of receiving system information are provided. The method of signalling system information includes broadcasting a piece of system information in a radio cell, the piece of system information indicating that a first portion of a frequency spectrum, the frequency spectrum being available for the radio cell, is assigned to a first radio mode, the piece of system information further indicating that a second portion of the frequency spectrum is assigned to a second radio mode, the second radio mode being different from the first radio mode. A radio base station is configured to perform the method of signalling system information. A radio communication terminal is configured to receive the broadcasted piece of system information.

### TECHNICAL FIELD

Embodiments of the invention relate generally to a method of signalling system information, to a method of receiving system information, to a radio base station and to a radio communication terminal.

### BRIEF DESCRIPTION OF THE SEVERAL VIEWS OF THE DRAWINGS

FIG. 1 shows a method of signalling system information in accordance with an embodiment of the invention.

FIG. 2 shows a method of receiving system information in accordance with an embodiment of the invention.

FIG. 3 shows a radio cell with radio communication terminals using a first radio mode and with radio communication terminals using a second radio mode in accordance with an embodiment of the invention.

FIG. 4 shows a radio base station in accordance with an embodiment of the invention and shows a radio communication terminal in accordance with an embodiment of the invention.

FIG. 5 shows a first and a second configuration of a frequency spectrum in accordance with embodiments of the invention.

FIG. 6 shows a message flow diagram in accordance with an embodiment of the invention.

FIG. 7 shows a third and a fourth configuration of a frequency spectrum in accordance with embodiments of the invention.

FIG. 8 shows a fifth configuration of a frequency spectrum in accordance with an embodiment of the invention.

In the drawings, like reference characters generally refer to the same parts throughout the different views. The drawings are not necessarily to scale, emphasis instead generally being placed upon illustrating the principles of the invention.

### DETAILED DESCRIPTION OF THE INVENTION

The following detailed description explains exemplary embodiments of the present invention. Where applicable the description of a method embodiment is deemed to describe also the functioning of a corresponding apparatus embodiment and vice versa. The description is not to be taken in a limiting sense, but is made only for the purpose of illustrating the general principles of the invention. The scope of the invention, however, is only defined by the claims and is not intended to be limited by the exemplary embodiments described below.

The mobile communication system UMTS (Universal Mobile Telecommunications System) is currently enhanced in the 3GPP standardization committees. A current topic is the introduction of LTE (Long Term Evolution) into the Release 8 version of UMTS standards. With LTE the UMTS air interface will be further optimized for packet data transmission by improving the system capacity and the spectral efficiency. Amongst others, the maximum net transmission rate will be increased significantly, namely to 300 Mbps in the downlink transmission direction and to 75 Mbps in the uplink transmission direction. Further, LTE will support scalable frequency bandwidths including bandwidth values of 1.4, 3, 5, 10, 15 and 20 MHz and will be based on new multiple access methods, i.e. OFDMA/TDMA (Orthogonal Frequency Division Multiple Access/Time Division Multiple Access) in downlink and SC-FDMA/TDMA (Single Carrier-Frequency Division Multiple Access/Time Division Multiple Access) in uplink.

In parallel, a study is conducted in 3GPP for the further advancement of LTE towards an IMT (International Mobile Telecommunications)-Advanced radio interface technology, referred to as LTE-Advanced. The details of scope and objectives of the study are described in [1]. The IMT-Advanced activities have been commenced and are guided by ITU-R (International Telecommunications Union-Radiocommunication Sector). In line with user trends and technology developments the key objective of the IMT-Advanced activities is to develop mobile radio communication systems that include new capabilities that go beyond those of current IMT-2000 systems such as UMTS, CDMA2000. Key features to be supported by candidate IMT-Advanced systems have been set by ITU-R and include amongst others:
high quality mobile services;
worldwide roaming capability; and
peak data rates of 100 Mbps for high mobility environments and 1 Gbps for low mobility environments.

The current discussions in 3GPP related to LTE-Advanced are focused on the technologies to further evolve LTE in terms of spectral efficiency, cell edge throughput, coverage and latency based on the agreed requirements in [2]. Candidate technologies include multi-hop Relay, DL (downlink) network MIMO (also referred to as multi-site, multi-stream transmission) with up to 64 antennas (8×8 array) for transmission/reception, support of bandwidths >20 MHz by spectrum aggregation, flexible spectrum usage, spectrum sharing and inter-cell interference management.

It is generally desirable to make efficient use of the resources of a communication system. For example, it is desirable that communication equipment can be operated according to different communication standards or different releases of a communication standard. For example, it is desirable to use the frequency spectrum resources of a radio communication system in an efficient manner.

In accordance with embodiments of the invention, a method of signalling system information and a method of receiving system information are provided.

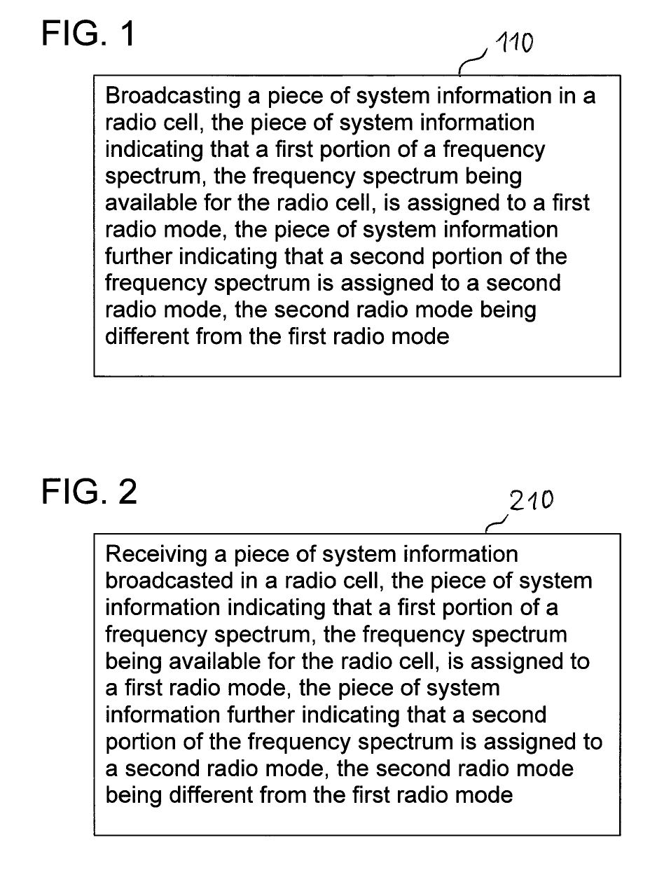

FIG. 1 shows a method of signalling system information in accordance with an embodiment of the invention.

In 110 a piece of system information is broadcasted in a radio cell, the piece of system information indicating that a first portion of a frequency spectrum, the frequency spectrum being available for the radio cell, is assigned to a first radio mode, the piece of system information further indicating that a second portion of the frequency spectrum is assigned to a second radio mode, the second radio mode being different from the first radio mode.

FIG. 2 shows a method of receiving system information in accordance with an embodiment of the invention.

In 210 a piece of system information broadcasted in a radio cell is received, the piece of system information indicating that a first portion of a frequency spectrum, the frequency spectrum being available for the radio cell, is assigned to a first radio mode, the piece of system information further indicating that a second portion of the frequency spectrum is assigned to a second radio mode, the second radio mode being different from the first radio mode.

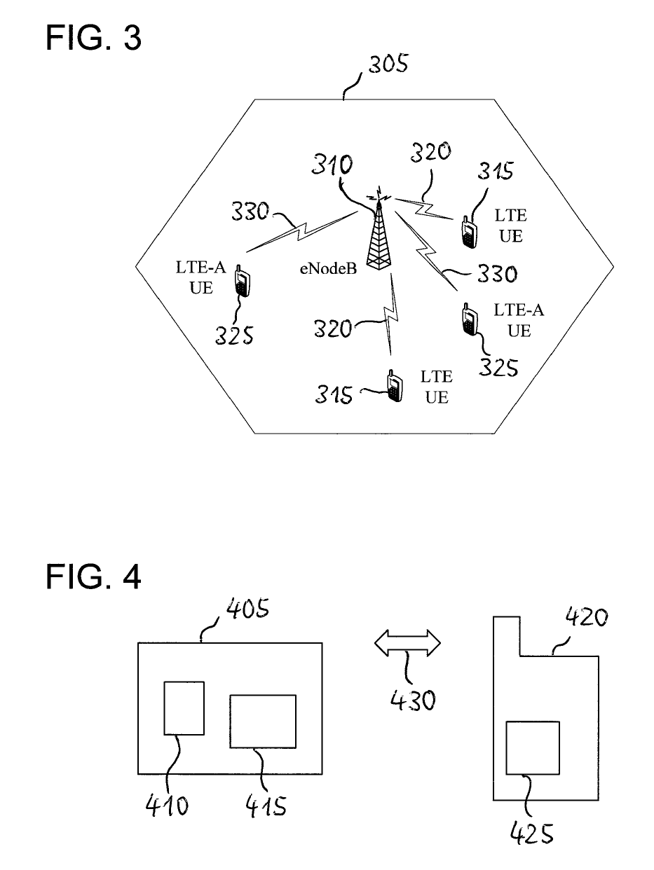

FIG. 3 shows a radio cell with radio communication terminals using a first radio mode and with radio communication terminals using a second radio mode in accordance with an embodiment of the invention. In this embodiment, the first radio mode is LTE and the second radio mode is LTE-Advanced.

A radio cell 305 is served by a base station (eNodeB) 310. This means, a radio communication terminal, also denoted as UE (user equipment), which is located in the radio cell, may have a communication connection with a communication network via an air interface provided by the base station. In the example shown, two LTE-UEs 315 may communicate with the base station 310 in LTE-mode through LTE radio channels 320. Two LTE-Advanced(“LTE-A”)-UEs 325 may communicate with the base station 310 in LTE-Advanced-mode through LTE-Advanced radio channels 330.

The term “LTE-mode” denotes an operation mode of an eNodeB. It means, that the transmission and reception of signals to and from UEs is fully compliant to the relevant specifications of LTE, i.e. the 3GPP specification for the radio protocols of E-UTRAN (evolved UMTS Terrestrial Radio Access Network) according to release 8.

The term “LTE-Advanced-mode” denotes an operation mode of an eNodeB. It means, that the transmission and reception of signals to and from UEs is fully compliant to the relevant specifications of LTE-Advanced, i.e. the 3GPP specification for the radio protocols according to release 10, which are currently not defined.

The term “LTE-UE” denotes an UE which does support LTE but does not support LTE-Advanced.

The term “LTE-Advanced-UE” denotes an UE, which is currently using LTE-Advanced. It is assumed that an UE that supports LTE-Advanced will typically also support LTE and will therefore also be suitable to access the LTE-part of a eNodeB designed to operate both in LTE-mode and LTE-Advanced-mode.

It is desirable that a future LTE-Advanced network shows backward compatibility with LTE. This means that UEs (user equipment, radio communication terminals) designed to be operated according to LTE should also be operable in a future LTE-Advanced environment. In the deployment scenario of FIG. 3 the base station 310 can be operated in LTE-mode as well as in LTE-Advanced-mode. It thus supports the LTE-Advanced-UEs 325 and also supports the LTE-UEs 315 which are both located in the radio cell 305. The LTE-UEs 315 can therefore be operated in the LTE-Advanced environment provided by the base station 310.

In an embodiment of the invention, an eNodeB designed for LTE-Advanced-mode operates a part (or portion) of the available frequency spectrum in LTE-mode in order to be able to support also LTE UEs. The bandwidth of this LTE part may be 1.4, 3, 5, 10, 15 or 20 MHz symmetric around the carrier frequency, and the transmission and reception of radio signals to and from an LTE-UE is performed as specified in the related LTE specifications. Additionally to the LTE part of the spectrum, the same eNodeB operates one or more frequency spectrum parts (portions) which are dedicated for LTE-Advanced-mode. These LTE-advanced parts could be adjacent in frequency domain to the LTE-part or could be separated from it. The total bandwidth of these LTE-advanced parts could be larger than 20 MHz. This has the effect to enable a smooth introduction of LTE-Advanced by keeping LTE running in the same radio cells for some further time.

In an embodiment of the invention, the spectrum available in an LTE-Advanced cell is divided in two parts: The first part is operated in LTE-mode. The second part is operated in LTE-Advanced-mode.

In an embodiment of the invention, the System Information transmitted in the LTE-part of the spectrum consists of two parts: The first part contains system information about the LTE-part of the spectrum. It appears unchanged from an LTE-UE's point of view and is additionally readable by LTE-Advanced-UEs. The second part contains system information about the LTE-Advanced-part of the spectrum. It is transparent for LTE-UEs and contains information about the bandwidth and frequency position of spectrum dedicated for use in LTE-Advanced-mode. It is readable by LTE-Advanced-UEs. The term “transparent for LTE-UEs” means, that LTE-UEs will not try to read this information. LTE-UEs recognise this information as not belonging to LTE-mode.

In an embodiment of the invention, the bandwidth partitioning between the LTE- and the LTE-Advanced-part is done dynamically based on the spectrum usage by LTE-resp. LTE-Advanced UEs. For that purpose, the eNodeB may monitor the amount of resources used by LTE-UEs and the amount of resources used by LTE-Advanced-UEs. This information may trigger the change of the bandwidth configuration with the aim to offer more bandwidth to the more active transmission mode. This has the effect that unused spectrum parts and overloaded spectrum parts may be avoided.

In an embodiment of the invention, system information is sent out by the eNodeB within the LTE part of the spectrum. This system information may be twofold, it may have one unchanged legacy part which can be used by LTE-UEs and may have one new part which can be used by LTE-Advanced-UEs. There may be additional system information that can be sent out in the LTE-Advanced part of the spectrum which is dedicated for LTE-Advanced-UEs.

In an embodiment of the invention, a first part of a system information sent within the LTE part of the spectrum is fully compatible with the LTE-specifications. It contains the parameters “dl-SystemBandwidth” (dl: downlink) in the MIB and “ul-Bandwidth” (ul: uplink) in SIB type 2, which is the bandwidth of the downlink and uplink, respectively, of the LTE part of the eNodeB serving both LTE and LTE-Advanced. An LTE-UE, that receives these values, will assume that the signaled “dl-SystemBandwidth” and “ul-Bandwidth” equals the complete spectrum that is used by this eNodeB, i.e. it will not recognize that there is additional spectrum available in the LTE-advanced part. The transmitted parameters will change, if the bandwidths used for the LTE-part are reconfigured, e.g. due to decrease of active LTE UEs and/or increase of active LTE-Advanced UEs.

In an embodiment of the invention, a second part of the system information sent within the LTE part of the spectrum is dedicated to LTE-Advanced-UEs. It contains the bandwidth and the frequency position of each LTE-Advanced-part of the spectrum used for downlink and uplink by the eNodeB serving both LTE and LTE-Advanced. For LTE-UEs this information is transparent, i.e. they will not try to read this information. LTE-UEs recognise this information as not belonging to LTE-mode. In contrast, LTE-Advanced-UEs will read and use this information. The second part of the system information may be transmitted in a new SIB type, e.g. SIB type 12, or as enhancement of an already existing SIB type or MIB.

To split the system information into an LTE- and an LTE-Advanced-part has the effect to enable LTE-UEs to access the eNodeB serving both LTE and LTE-Advanced.

To send LTE-Advanced related system information within the LTE-part of the spectrum has the effect to speed up the cell search procedure of an LTE-Advanced UE. In this case the same cell search procedure as specified in LTE may be reused in LTE-Advanced, i.e. there is no additional effort to find LTE-Advanced cells as the related system information is transmitted within the LTE-part of the spectrum. A further effect is that LTE-Advanced-eNodeBs can use spectrum parts for the LTE-Advanced operation, which are currently not available for mobile communication, without the need by UEs to scan these spectrum parts. To search the already known LTE-carrier-frequencies is sufficient, based on the described signalling of system information for both LTE and LTE-Advanced in the LTE-part of the spectrum. With this signalling an operator can easily add new spectrum to one or more of his eNodeBs and make them available for the UEs by simply changing the corresponding parameters of the system information for both LTE and LTE-Advanced sent within the LTE part of the spectrum.

FIG. 4 shows a radio base station in accordance with an embodiment of the invention and shows a radio communication terminal in accordance with an embodiment of the invention.

A radio base station (eNodeB) 405 has a broadcasting unit 410. The broadcasting unit 410 is configured to broadcast a piece of system information in a radio cell, the piece of system information indicating that a first portion of a frequency spectrum, the frequency spectrum being available for the radio cell, is assigned to a first radio mode, the piece of system information further indicating that a second portion of the frequency spectrum is assigned to a second radio mode, the second radio mode being different from the first radio mode.

The radio base station 405 further has a partitioning unit 415, which is configured to partition the frequency spectrum into the first and second portions.

The radio base station 405 is configured to operate the radio cell in the first radio mode using the first portion of the frequency spectrum and is further configured to operate the radio cell in the second radio mode using the second portion of the frequency spectrum.

In an embodiment of the invention the first portion of the frequency spectrum and the second portion of the frequency spectrum are not adjacent to each other.

A radio communication terminal (UE) 420 has a receiving unit 425. The receiving unit 425 is configured to receive a piece of system information broadcasted in a radio cell, the piece of system information indicating that a first portion of a frequency spectrum, the frequency spectrum being available for the radio cell, is assigned to a first radio mode, the piece of system information further indicating that a second portion of the frequency spectrum is assigned to a second radio mode, the second radio mode being different from the first radio mode.

When the radio communication terminal 420 is located in a radio cell served by the radio base station 405, the radio communication terminal 420 may have a communication connection with a communication network via an air interface 430 provided by the base station 405. The radio communication terminal 420 may communicate with the base station 405 in the first radio mode using the first portion of the frequency spectrum, e.g. in LTE-mode through LTE radio channels provided within the air interface 430. The radio communication terminal 420 may communicate with the base station 405 in the second radio mode using the second portion of the frequency spectrum, e.g. in LTE-Advanced-mode through LTE-Advanced radio channels provided within the air interface 430.

In an embodiment of the invention, a base station (eNodeB) serving both LTE and LTE-Advanced in a radio cell has a capability to detect the number of LTE-UEs and of LTE-Advance-UEs that are currently active in the radio cell. This may be done by observing the supported bandwidth of each UE that is signaled to the network and/or by an explicit indication of the supported mode (LTE or LTE-Advanced) or supported Specification-Release (Release 8 and 9 for LTE and Release 10 for LTE-Advanced). Additionally it may have the capability to retrieve the amount of resources used by LTE-UEs and the amount of resources used by LTE-Advanced-UEs.

In an embodiment of the invention, a base station (eNodeB) serving both LTE and LTE-Advanced in a radio cell has a capability to change the bandwidth used for LTE-operation and LTE-Advanced operation e.g. due to the ratio of active LTE-UEs to LTE-Advanced-UEs. The higher the ratio the larger may be the bandwidth used for the LTE-part. Additionally the bandwidth may change if the policies for the spectrum usage are changed.

In an embodiment of the invention, a base station (eNodeB) serving both LTE and LTE-Advanced in a radio cell has a capability to assign resources of different spectrum parts based on UE capabilities (LTE or LTE-Advanced).

In an embodiment of the invention, an LTE-Advanced-UE has a capability to perform cell search procedure as specified for LTE.

In an embodiment of the invention, an LTE-Advanced-UE has a capability to read the LTE-Advanced system information sent out by an eNodeB within the LTE part of the spectrum.

In an embodiment of the invention, an LTE-Advanced-UE has a capability to set up its transceiver appropriately to the LTE-Advanced system information, e.g. to calculate the carrier frequency F_{C,LTE-Adv.} and to change the center frequency of the transceiver to this value if it differs from the currently used center frequency, which is F_{C,LTE} after performing cell search.

Embodiments of the invention relate to an LTE-Advanced system supporting bandwidths larger than 20 MHz and flexible spectrum usage/spectrum sharing. Embodiments of the invention have the effect to enable an LTE network transmitter station (called eNodeB) to be operated simultaneously in LTE- and LTE-Advanced mode and to configure spectrum sharing between these technologies dynamically. Embodiments of the invention have the effect to allow that at the time of introduction of LTE-Advanced the spectrum used for LTE is larger than that used for LTE-Advanced and vice versa at the time when LTE-Advanced terminals are broadly in use. Embodiments of the invention have the effect to enable mobile LTE terminals (called UE) to get access to an LTE-Advanced cell and eNodeB resp., i.e. at least part of the LTE-Advanced spectrum is fully backwards compatible to the LTE specifications.

Embodiments of the invention have the effect to enable to transmit different system information to UEs using different releases of a radio communication standard (e.g. LTE and LTE-Advanced) in the same radio cell, e.g. to transmit the different system bandwidths for LTE and LTE-Advanced. An LTE eNodeB transmits periodically so called “System Information” on which important system- and cell-related information are broadcasted to all UEs located in the cell. The most important information is transmitted in the so called “Master Information Block” (MIB). This information is required by an UE to receive further system information. The MIB is transmitted once every frame and uses 72 subcarriers around the Carrier Frequency. It also contains the parameter “dl-System-Bandwidth” which is the bandwidth used in downlink direction, i.e. from eNodeB to UE. Further system information is transmitted in so called “System Information Blocks” (SIB). Currently, 11 SIB types are defined in the LTE System. The bandwidth used in the uplink direction is transmitted in SIB type 2. A system information related to LTE-Advanced may be transmitted in a new SIB type, e.g. SIB type 11, or as enhancement of an already existing SIB type or MIB, within the LTE part of the spectrum.

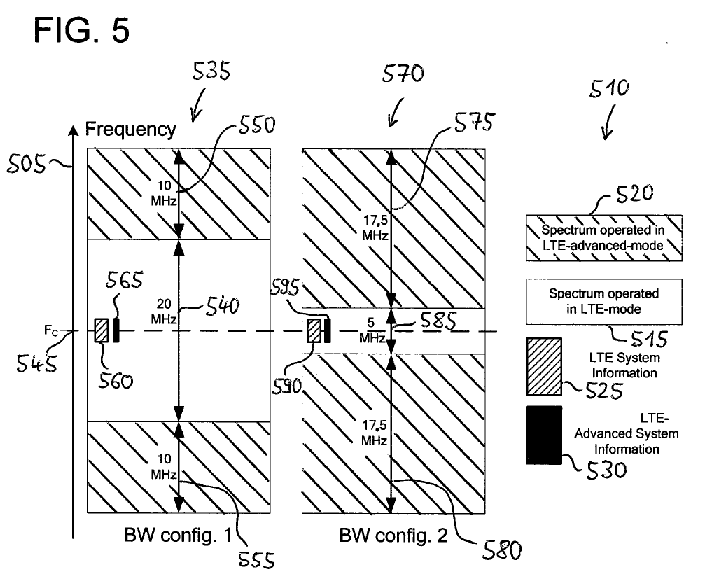

In the following, several embodiments of the invention illustrating principles how to configure the bandwidth used in the downlink are described with reference to FIGS. 5, 6, 7 and 8.

To simplify the description, the configuration of the uplink bandwidth, which is similar to that of the downlink bandwidth, is not shown in FIGS. 5, 6, 7 and 8. The same principles as for the downlink are applicable to the uplink accordingly. The signalling for the uplink bandwidth may be done by using the parameter “ul-bandwidth” for the LTE-part which is transmitted in SIB type 2 and by using new parameters for the LTE-Advanced parts which are transmitted e.g. in new SIB type 11 as shown in the following for the downlink.

FIG. 5 shows a first and a second configuration of a frequency spectrum in accordance with embodiments of the invention.

The frequency spectrum is shown in a coordinate system having a frequency coordinate 505. The coordinate direction perpendicular to the frequency coordinate 505 is used to illustrate different spectrum configurations and to illustrate different time instants (transmission window positions in time) within a spectrum configuration. Portions of the radio frequency spectrum which are defined by frequency intervals and time intervals are allocated to LTE and LTE-Advanced, respectively. In a legend 510 outside the frequency spectrum it is shown how an allocation of radio frequency spectrum portions to LTE-mode operation 515, LTE-Advanced-mode operation 520, LTE System Information 525 and LTE-Advanced System Information 530, respectively, is symbolized in the drawing.

We are now assuming that the eNodeB is using a first bandwidth configuration “BW config. 1” 535. This means that the total bandwidth of this cell is 40 MHz, of which a 20 MHz portion 540 positioned symmetrically around the center frequency 545 is used for the LTE-part and two 10 MHz LTE-Advanced-parts 550 and 555 are adjacent to the LTE-part (portion) 540. Let's further assume that 10 LTE-UEs and 10 LTE-Advanced-UEs are currently active in the cell. Each active UE is receiving data with 2 Mbit/s average data rate and thus is consuming 1 MHz of bandwidth in average. The LTE-UEs receive LTE System Information 560 in the LTE portion 540. The LTE-Advanced-UEs receive both LTE System Information 560 and LTE-Advanced System Information 565 in the LTE portion 540.

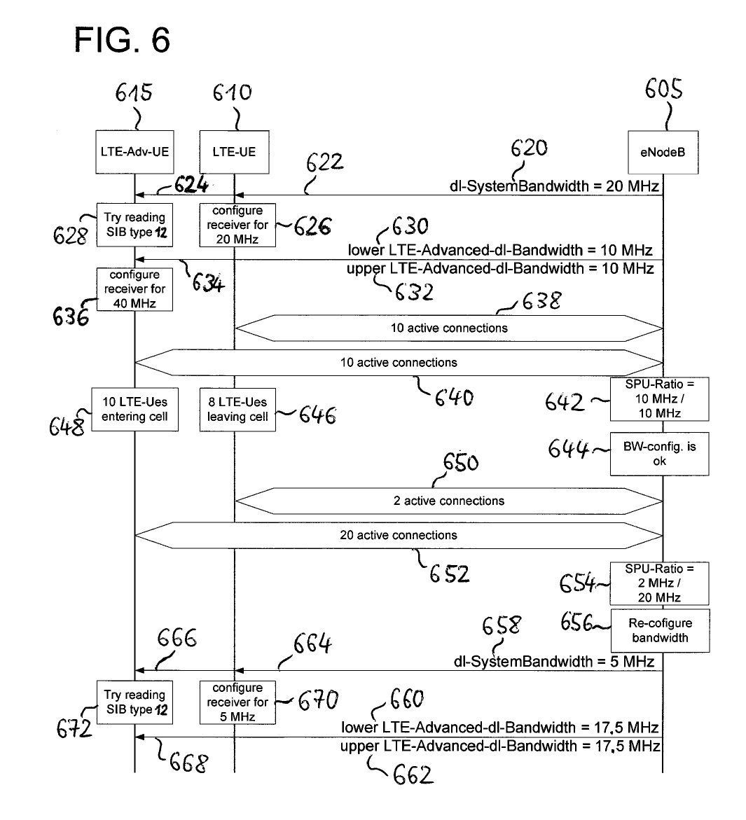

FIG. 6 shows a message flow diagram in accordance with an embodiment of the invention. The message flow diagram refers to the situation described in connection with the frequency spectrum configurations of FIG. 5. The message exchange and the corresponding behavior of an eNodeB 605, an exemplary LTE-UE 610 and an exemplary LTE-Advanced-UE 615 are illustrated in the following.

The parameter “dl-SystemBandwidth” 620 is broadcasted by the eNodeB 605 in the MIB in the LTE System Information 560 in the LTE-part (portion) 540 of the spectrum with the value “20 MHz”. It is transmitted at 622 to the LTE-UE 610 and at 624 to the LTE-Advanced-UE 615. At 626 the LTE-UE 610 configures its receiver for the LTE bandwidth of 20 MHz. At 628 the LTE-Advanced-UE 615 starts trying to read an SIB type 12 associated with LTE-Advanced.

Additionally the eNodeB 605 broadcasts a SIB type 12 in the LTE-Advanced System Information 565 in the LTE-part (portion) 540 of the spectrum. The SIB type 12 contains the new parameters “lower LTE-Advanced-dl-Bandwidth” 630 and “upper LTE-Advanced-dl-Bandwidth” 632. Both parameters are transmitted with the same value of 10 MHz at 634 to the LTE-Advanced-UE 615. At 636, since the attempt to read the SIB type 12 now was successful, the LTE-Advanced-UE 615 configures its receiver for the LTE-Advanced bandwidth of two portions 550 and 555 of 10 MHz each, i.e. configures its receiver for a frequency window positioned symmetrically around the center frequency 545 and having a total bandwidth of 40 MHz.

The eNodeB (base station) 605 is monitoring the amount of resources used by LTE-UEs 610 and the amount of resources used by LTE-Advanced-UEs 615. The ratio of this two values is called “Spectrum-part usage ratio” (SPU-Ratio) in the following. Currently 10 LTE-UEs 610 are active in the cell (“10 active connections” 638) and 10 LTE-Advanced-UEs 615 are active in the cell (“10 active connections” 640). Since each active UE is assumed to receive data with 2 Mbit/s average data rate and thus is consuming 1 MHz of bandwidth in average, the SPU-Ratio at 642 is 10 MHz/10 Mhz (=1). At 644 the eNodeB 605 decides that the current partitioning into the LTE portion 540 and the two LTE-Advanced portions 550 and 555 is adequate for the current usage of LTE frequency resources and LTE-Advanced frequency resources, respectively.

Now, we assume that 8 active LTE-UEs are leaving the cell at 646, and 10 additional active LTE-Advanced-UEs are entering the cell at 648. This means, now only 2 LTE-UEs 610 are active in the cell (“2 active connections” 650) but 20 LTE-Advanced-UEs 615 are active in the cell (“20 active connections” 652). The SPU-Ratio is now decreased to 2 MHz/20 MHz (=0.1). The eNodeB 605 monitors the decreased SPU-Ratio at 654. The decreased SPU-Ratio is the trigger for the eNodeB 605 to change the bandwidth configuration. At 656 the eNodeB 605 decides to re-configure the bandwidth.

In FIG. 5 the re-configured bandwidth configuration is shown. The eNodeB 605 now uses a second bandwidth configuration “BW config. 2” 570. Compared to the previously used configuration the LTE-Advanced-part now is increased to have two portions 575 and 580 of 17.5 MHz each (for usage by the “20 active connections” 652) and the LTE-part is decreased to have a portion 585 of only 5 MHz (for usage by the “2 active connections” 654). The LTE-UEs 610 receive LTE System Information 590 in the now decreased LTE portion 585. The LTE-Advanced-UEs 615 receive both LTE System Information 590 and LTE-Advanced System Information 595 in the now decreased LTE portion 585.

Again referring to FIG. 6, the eNodeB accordingly broadcasts new values for the bandwidth parameters: “dl-SystemBandwidth=5 MHz” 658 (in the MIB in the LTE System Information 590 in the LTE portion 585 of the spectrum), “lower LTE-Advanced-dl-Bandwidth=17.5 MHz” 660 and “upper LTE-Advanced-dl-Bandwidth=17.5 MHz” 662 (both in the SIB type 12 in the LTE-Advanced System Information 595 in the LTE portion 585 of the spectrum). The parameter “dl-SystemBandwidth=5 MHz” 658 is transmitted at 664 to the LTE-UE 610 and at 666 to the LTE-Advanced-UE 615. Both parameters “lower LTE-Advanced-dl-Bandwidth=17.5 MHz” 660 and “upper LTE-Advanced-dl-Bandwidth=17.5 MHz” 662 are transmitted at 668 to the LTE-Advanced-UE 615.

All UEs in the cell re-configure their transceivers to these new values. The LTE-UE 610 configures its receiver at 670 and now uses a bandwidth of 5 MHz. At 672, after having received the information about the new LTE bandwidth of 5 MHz, the LTE-Advanced-UE 615 starts trying to read an SIB type 12 associated with LTE-Advanced. After having received, at 668, the SIB type 12 indicating that 2 times 17.5 MHz should be used for LTE-Advanced, the LTE-Advanced-UE 615 recognises that its receiver should be set to (2 times 17.5 MHz) plus (5 MHz)=40 MHz. Since in this case the receiver has already been configured, at 636, for a total bandwidth of 40 MHz, the receiver configuration is not changed.

The LTE-Advanced-UEs 615 may use both parts (LTE portion 585 and LTE-Advanced portions 575, 580) of the spectrum, if scheduled appropriately by the eNodeB 605. But nevertheless they will operate in LTE-mode if scheduled in the LTE-part (portion 585) and in LTE-Advanced-mode if scheduled in the LTE-Advanced-part (portions 575, 580).

In the two cases of “BW config. 1” 535 and “BW config. 2” 570 both UE types, i.e. LTE-UEs 610 and LTE-Advanced-UEs 615 have tuned their receivers to the carrier frequency F_{C} (center frequency) 545.

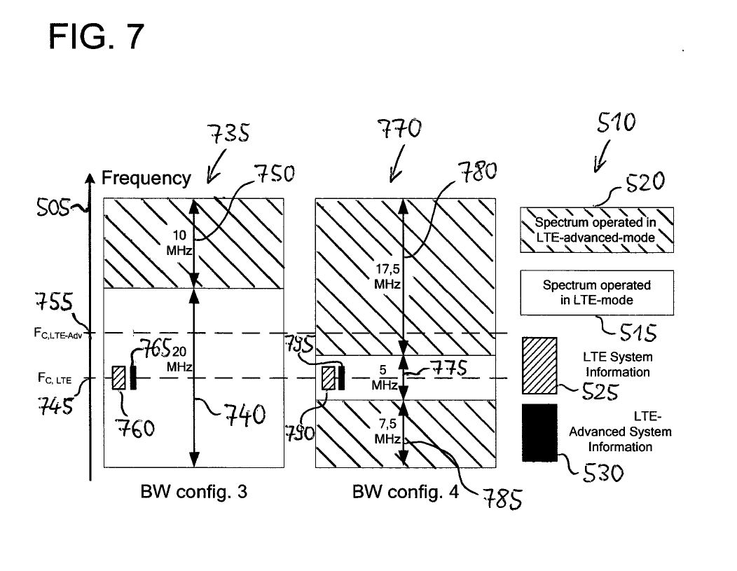

FIG. 7 shows a third and a fourth configuration of a frequency spectrum in accordance with embodiments of the invention.

Like in FIG. 5, the frequency spectrum is shown in FIG. 7 in a coordinate system having a frequency coordinate 505. The coordinate direction perpendicular to the frequency coordinate 505 is used to illustrate different spectrum configurations and to illustrate different time instants (transmission window positions in time) within a spectrum configuration. Portions of the radio frequency spectrum which are defined by frequency intervals and time intervals are allocated to LTE and LTE-Advanced, respectively. In a legend 510 outside the frequency spectrum it is shown how an allocation of radio frequency spectrum portions to LTE-mode operation 515, LTE-Advanced-mode operation 520, LTE System Information 525 and LTE-Advanced System Information 530, respectively, is symbolized in the drawing.

Now, we assume, that the eNodeB first uses a third bandwidth configuration “BW config. 3” 735. The total bandwidth of this cell is 30 MHz. A portion 740 of 20 MHz is located symmetrically around the LTE center frequency (F_{C,LTE}) 745. This part is operated in LTE-mode. A portion 750 of 10 MHz is located in frequency adjacent above the LTE-part and is used in LTE-Advanced-mode.

For signalling the “BW config. 3” 735, the eNodeB transmits the parameters “dl-SystemBandwidth”=20 MHz in the MIB and “upper LTE-Advanced-dl-Bandwidth”=10 MHz in SIB type 12. The parameter “lower LTE-Advanced-dl-Bandwidth” is not needed for signalling the “BW config. 3” 735. LTE-UEs will tune their receivers to the LTE center frequency (F_{C,LTE}) 745. LTE-Advanced-UEs have to calculate the applicable LTE-Advanced center-frequency (F_{C,LTE-Adv.}) 755 by adding “upper LTE-Advanced-dl-Bandwidth”/2 (=10/2 MHz=5 MHz) to the LTE center frequency (F_{C,LTE}) 745. In case that in a similar frequency configuration the LTE-Advanced part is in frequency adjacent below the LTE-part, the value of “lower LTE-Advanced-dl-Bandwidth”/2 is subtracted from F_{C,LTE} to derive F_{C,LTE-Adv.} LTE-Advanced-UEs will tune their receivers to the LTE-Advanced center-frequency (F_{C,LTE-Adv.}) 755.

In the “BW config. 3” 735 the LTE-UEs in this radio cell receive LTE System Information 760 in the LTE portion 740. The LTE-Advanced-UEs in this radio cell receive both LTE System Information 760 and LTE-Advanced System Information 765 in the LTE portion 740.

Now it is assumed that the eNodeB reconfigures the bandwidth distribution and switches to a fourth bandwidth configuration “BW config. 4” 770 shown also in FIG. 7. The total bandwidth of this cell is again 30 MHz. A portion 775 of 5 MHz is located symmetrically around the LTE center frequency (F_{C,LTE}) 745. This part is operated in LTE-mode. A portion 780 of 17.5 MHz is located in frequency adjacent above the LTE-part and is used in LTE-Advanced-mode. Another portion 785 of 7.5 MHz is located in frequency adjacent below the LTE-part and is also used in LTE-Advanced-mode.

For signalling the “BW config. 4” 770, the eNodeB transmits the parameter “dl-SystemBandwidth”=20 MHz in the MIB and transmits the parameters “upper LTE-Advanced-dl-Bandwidth”=17.5 MHz and “lower LTE-Advanced-dl-Bandwidth”=7.5 MHz in SIB type 12. LTE-UEs will tune their receivers to the LTE center frequency (F_{C,LTE}) 745. LTE-Advanced-UEs have to calculate the applicable LTE-Advanced center-frequency (F_{C,LTE-Adv.}) 755 by adding “upper LTE-Advanced-dl-Bandwidth”/2 (=17.5/2=8.75 MHz) to the LTE center frequency (F_{C,LTE}) 745 and subtracting “lower LTE-Advanced-dl-Bandwidth”/2 (=7.5/2 MHz=3.75 MHz) from the LTE center frequency (F_{C,LTE}) 745. In the case shown the calculation yields F_{C,LTE-Adv.}=F_{C,LTE}+8.75 MHz−3.75 MHz=F_{C,LTE}+5 MHz. LTE-Advanced-UEs will then tune their receivers to the LTE-Advanced center-frequency (F_{C,LTE-Adv.}) 755.

In the “BW config. 4” 770 the LTE-UEs in this radio cell receive LTE System Information 790 in the LTE portion 775. The LTE-Advanced-UEs in this radio cell receive both LTE System Information 790 and LTE-Advanced System Information 795 in the LTE portion 775.

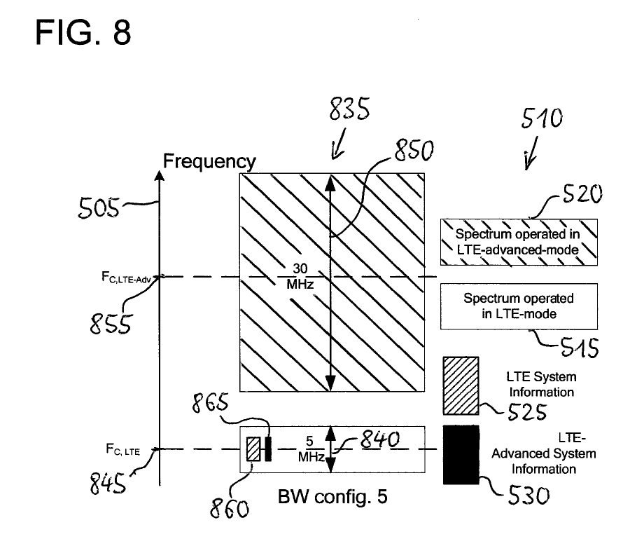

FIG. 8 shows a fifth configuration of a frequency spectrum in accordance with an embodiment of the invention.

Like in FIG. 5, the frequency spectrum is shown in FIG. 8 in a coordinate system having a frequency coordinate 505. The coordinate direction perpendicular to the frequency coordinate 505 is used to illustrate different spectrum configurations and to illustrate different time instants (transmission window positions in time) within a spectrum configuration. Portions of the radio frequency spectrum which are defined by frequency intervals and time intervals are allocated to LTE and LTE-Advanced, respectively. In a legend 510 outside the frequency spectrum it is shown how an allocation of radio frequency spectrum portions to LTE-mode operation 515, LTE-Advanced-mode operation 520, LTE System Information 525 and LTE-Advanced System Information 530, respectively, is symbolized in the drawing.

In this example the eNodeB uses a fifth bandwidth configuration “BW config. 5” 835. The total bandwidth of this cell is 5 MHz+30 MHz=35 MHz. A portion 840 of 5 MHz is located symmetrically around the LTE center frequency (F_{C,LTE}) 845. This part is operated in LTE-mode. The LTE-Advanced part of the spectrum is a portion 850 of 30 MHz bandwidth which is in the frequency domain separated from the LTE-part, i.e. not adjacent to the portion 840.

For signalling the “BW config. 5” 835, the eNodeB transmits the parameter “dl-SystemBandwidth”=5 MHz in the MIB and transmits the parameters “separated LTE-Advanced-dl-Bandwidth”=30 MHz and “separated LTE-Advanced-dl-CarrierFrequency”=F_{C,LTE-Adv.} in SIB type 12. LTE-UEs will tune their receivers to the LTE center frequency (F_{C,LTE}) 845. LTE-Advanced-UEs will tune their receivers to the LTE-Advanced center-frequency (F_{C,LTE-Adv.}) 855 given by the value of F_{C,LTE-Adv.} transmitted in SIB type 12.

In the “BW config. 5” 835 the LTE-UEs in this radio cell receive LTE System Information 860 in the LTE portion 840. The LTE-Advanced-UEs in this radio cell receive both LTE System Information 860 and LTE-Advanced System Information 865 in the LTE portion 840.

According to an embodiment of the invention, any embodiment defined by one of the claims may be combined with any one or more other embodiments defined by respective one or more of the other claims.

The following publications are cited in this document:
[1] RP-080137, Further advancements for E-UTRA (LTE-Advanced), NTT DoCoMo et al., available at internet location “http://www.3gpp.org/ftp/Information/WI_Sheet/RP-080137.zip”;
[2] 3GPP TS 36.913 V1.0.0 (2008-05): Requirements for further advancements for E-UTRA (LTE-Advanced), available at internet location “http://www.3gpp.org/ftp/Specs/archive/36_series/36.913/36913-800.zip”.

1. A method of signalling system information, comprising:
broadcasting a piece of system information in a radio cell, the piece of system information indicating that a first portion of a frequency spectrum, the frequency spectrum being available for the radio cell, is assigned to a first radio mode, the piece of system information further indicating that a second portion of the frequency spectrum is assigned to a second radio mode, the second radio mode being different from the first radio mode.

2. The method as recited in claim 1, wherein the first radio mode and the second radio mode are radio modes according to different radio communication standards.

3. The method as recited in claim 1, wherein the first radio mode and the second radio mode are radio modes according to different releases of the same radio communication standard.

4. The method as recited in claim 1, wherein the first radio mode and the second radio mode are not compatible with each other for operation in a common frequency spectrum.

5. The method as recited in claim 1, wherein the first radio mode and the second radio mode both include Orthogonal Frequency Division Multiple Access.

6. The method as recited in claim 1, wherein the first radio mode is a Long Term Evolution (“LTE”)-mode of the Universal Mobile Telecommunications System, and wherein further the second radio mode is an LTE-Advanced-mode of the Universal Mobile Telecommunications System.

7. The method as recited in claim 1, wherein at least one of the first and second portions comprises a plurality of frequency spectrum parts which are not adjacent to each other.

8. The method as recited in claim 1, wherein the piece of system information comprises a first part relating to the first radio mode and further comprises a second part relating to the second radio mode.

9. The method as recited in claim 8, wherein the broadcasting comprises broadcasting the second part in the first portion of the frequency spectrum.

10. The method as recited in claim 8, wherein the second part comprises a frequency position of the second portion of the frequency spectrum.

11. The method as recited in claim 8, wherein the second part comprises a frequency bandwidth of the second portion of the frequency spectrum.

12. The method as recited in claim 1, further comprising:
partitioning the frequency spectrum into the first and second portions.

13. The method as recited in claim 12, wherein the partitioning comprises partitioning the frequency spectrum into the first and second portions dynamically.

14. The method as recited in claim 12, wherein the partitioning comprises adapting the first and second portions dynamically according to respective uses of frequency spectrum resources in the first radio mode and in the second radio mode.

15. The method as recited in claim 1, further comprising:
operating the radio cell in the first radio mode using the first portion of the frequency spectrum; and
operating the radio cell in the second radio mode using the second portion of the frequency spectrum.

16. The method as recited in claim 15, wherein the operating in the first radio mode comprises operating in the first radio mode by a radio base station, and wherein further the operating in the second radio mode comprises operating in the second radio mode by the radio base station.

17. The method as recited in claim 15, wherein the operating in the first radio mode and the operating in the second radio mode are performed simultaneously.

18. A radio base station, comprising:
a broadcasting unit to broadcast a piece of system information in a radio cell, the piece of system information indicating that a first portion of a frequency spectrum, the frequency spectrum being available for the radio cell, is assigned to a first radio mode, the piece of system information further indicating that a second portion of the frequency spectrum is assigned to a second radio mode, the second radio mode being different from the first radio mode.

19. The radio base station as recited in claim 18, further comprising:
a partitioning unit to partition the frequency spectrum into the first and second portions.

20. The radio base station as recited in claim 18, wherein the radio base station is configured to operate the radio cell in the first radio mode using the first portion of the frequency spectrum and configured to operate the radio cell in the second radio mode using the second portion of the frequency spectrum.

21. A method of receiving system information, comprising:
receiving a piece of system information broadcasted in a radio cell, the piece of system information indicating that a first portion of a frequency spectrum, the frequency spectrum being available for the radio cell, is assigned to a first radio mode, the piece of system information further indicating that a second portion of the frequency spectrum is assigned to a second radio mode, the second radio mode being different from the first radio mode.

22. The method as recited in claim 21, wherein the piece of system information comprises a first part relating to the first radio mode and further comprises a second part relating to the second radio mode.

23. The method as recited in claim 22, wherein the receiving comprises receiving the second part in the first portion of the frequency spectrum.

24. The method as recited in claim 22, further comprising:
accessing the radio cell, based on the second part, in the second radio mode using the second portion of the frequency spectrum.

25. A radio communication terminal, comprising:
a receiving unit to receive a piece of system information broadcasted in a radio cell, the piece of system information indicating that a first portion of a frequency spectrum, the frequency spectrum being available for the radio cell, is assigned to a first radio mode, the piece of system information further indicating that a second portion of the frequency spectrum is assigned to a second radio mode, the second radio mode being different from the first radio mode.
